(19) United States
(12) Patent Application Publication
(10) Pub. No.: US 2016/0335981 A1
(43) Pub. Date: Nov. 17, 2016

(54) REMOTE CONTROL METHOD AND DEVICE USING WEARABLE DEVICE

(71) Applicant: Samsung Electronics Co., Ltd., Gyeonggi-do (KR)

(72) Inventors: Bon-Hyun KOO, Gyeonggi-do (KR); Tae-Won AHN, Gyeonggi-do (KR); Dong-Keon KONG, Gyeonggi-do (KR); Young-Kyu KIM, Seoul (KR); Jun-Hyung KIM, Gyeonggi-do (KR); Du-San BAEK, Seoul (KR)

(73) Assignee: Samsung Electronics Co., Ltd.

(21) Appl. No.: 15/153,157

(22) Filed: May 12, 2016

(30) Foreign Application Priority Data
May 12, 2015 (KR) 10-2015-0066288

(51) Int. Cl. G09G 5/00; G02B 27/00; G02B 27/01; H04N 5/44; G06F 3/01

(52) U.S. Cl. CPC G09G 5/003; H04N 5/44; G06F 3/011; G02B 27/0172; G02B 27/0093; G02B 2027/0178; G02B 2027/0138

(57) ABSTRACT

Remote control methods, systems, and devices are described. In one aspect, a remote control method using a wearable device is provided. In the method, a communication connection is established with a remote camera over a network and the field of view (FoV) of the remote camera is controlled according to a detected movement of the user wearing the wearable device.

### PRIORITY

This application claims priority under 35 U.S.C. §119(a) to a Korean Patent Application filed in the Korean Intellectual Property Office on May 12, 2015 and assigned Serial No. 10-2015-0066288, the entire disclosure of which is incorporated herein by reference.

### BACKGROUND

1. Field of the Disclosure

The present disclosure generally relates to a method and device for remotely controlling a device, and more particularly, to a remote control method and device using a wearable device.

2. Description of the Related Art

The Internet has evolved from a human-centered connection network in which humans may create and consume information, into the Internet of Things (IoT) in which distributed components such as electrical and electronic components may exchange and process information. For example, in the Internet of Everything (IoE), Big Data processing technology is combined through the connection to a cloud server and the like with IoT technology.

In order to implement IoT, technical factors such as sensing technology, wired/wireless communication and network infrastructure, service interface technology and security technology may be required. In recent years, technologies for connection between things, such as sensor networks, machine-to-machine (M2M) and machine type communication (MTC), have been studied.

In the IoT environment, an intelligent Internet technology (IT) service may be provided, in which the connected things may collect and analyze data generated therein to create new value for human lives. IoT is applied to create the fields of smart home, smart building, smart city, smart car or connected car, smart grid, smart health care, smart appliances and high-tech medical services, through the convergence between the existing IT technology and various industries.

Due to the full-fledged adaptation of IoT services, technologies to realize services through linking various devices to a single network have been introduced. IoT is technology in which all the network-based devices are seamlessly connected to each other. The IoT technology is required in a variety of IT services. For the realization of IoT services, a variety of wearable devices have been introduced to the market. Typical types of wearable devices include smart watch-type devices such as Apple iWatch™ and Samsung Galaxy GearS™, and head-mounted display (HMD) devices such as Google Glass™ and Samsung GearVR™. Further, various studies are underway for mobile or wearable devices that are based on IoT technologies, such as, for example, the smart home.

### SUMMARY

According to aspects of the present disclosure, a method and device for remotely controlling other devices using a wearable device are provided. Further, the present disclosure provides a method and device for remotely controlling a camera using a wearable device. In addition, the present disclosure provides a method and device for remotely controlling at least one camera within a building system using a wearable device. Moreover, the present disclosure provides a method and device for remotely controlling a camera or other device using a mobile device.

In accordance with an aspect of the present disclosure, a method of remote control using a wearable device is provided, including establishing a communication connection with a remote camera over a network; and controlling a field of view of the remote camera according to a detected movement of a user wearing the wearable device.

In accordance with another aspect of the present disclosure, a wearable device is provided, including a communication interface; a sensor unit; and a controller configured to establish a communication connection with a remote camera over a network, and control a field of view of the remote camera according to a movement of the user wearing the wearable device detected by the sensor unit.

In accordance with another aspect of the present disclosure, a method for remote control using a mobile device is provided, including establishing, by the mobile device, a communication connection with a remote camera over a network; and controlling a field of view of the remote camera according to a movement of the mobile device detected by a sensor, wherein controlling includes compensating for noise data of the sensor detecting the movement.

In accordance with another aspect of the present disclosure, a mobile device is provided, including a display unit; a communication interface; a sensor unit; and a controller configured to establish a communication connection with a remote camera over a network via the communication interface, and control a field of view of the remote camera according to a movement detected by the sensor unit, wherein controlling the FoV includes compensating for noise data of the sensor unit detecting the movement.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating an example of a user interface screen for pan/tilt/zoom (P/T/Z) control of a remote network camera using a mobile device such as a smart phone;

FIG. 2 is a diagram illustrating an example of a system for controlling the movement of at least one camera installed at a remote site using a wearable device according to an embodiment of the present disclosure;

FIG. 3A is a block diagram illustrating an example of a wearable device and a remote-controlled camera according to an embodiment of the present disclosure;

FIG. 3B is a diagram illustrating an example of a remote control system for controlling a camera and an end device installed at a remote site using a wearable device according to an embodiment of the present disclosure;

FIG. 4 is a diagram illustrating an example of a communication interface that may be used in accordance with an embodiment of the present disclosure;

FIG. 5 is a diagram illustrating head movements for a camera control method using a wearable device according to an embodiment of the present disclosure;

FIG. 6A is a diagram illustrating hand movements using a pair of smart watches for a camera control method using a wearable device according to another embodiment of the present disclosure;

FIG. 6B is a diagram illustrating a touch input directly on a wearable device according to another embodiment of the present disclosure;

FIG. 7 illustrates pan and tilt control operations of a remote camera according to an embodiment of the present disclosure;

FIG. 8 is a graph of sensor data of remote camera control using head tracking in a wearable device according to an embodiment of the present disclosure;

FIG. 9 illustrates an example of controlling an end device installed at a remote site using a wearable device supporting augmented reality (AR) according to an embodiment of the present disclosure; and

FIG. 10 illustrates an example of controlling an operation of an end device installed at a remote site using a mobile device supporting AR according to an embodiment of the present disclosure.

### DETAILED DESCRIPTION

In the following description of embodiments of the present disclosure, detailed descriptions of known functions or configurations are omitted in order to avoid unnecessarily obscuring the subject matter of the present disclosure. Throughout the drawings, like reference numerals will be understood to refer to like parts, components, and structures.

With the development of IoT technologies, a variety of IoT services using wearable devices have been introduced. The present disclosure provides, as examples of IoT services, a monitoring service, an access management service or a security monitoring service (hereinafter, remote monitoring service) by controlling at least one camera installed in a home network or a building system through a wearable device, and proposes services for controlling operations of other devices, which are identified through a camera installed in the home network or the building system.

A remote monitoring service using a camera in the home network or the building system is described below. In this embodiment, a dedicated application is required to be installed in the user terminal in order to control the remote device, i.e., the camera installed in the home network or the building system, and a user's manual key input is required in order to transmit a user's control command to the device. In this case, there may be spatial constraints for remote control of the device.

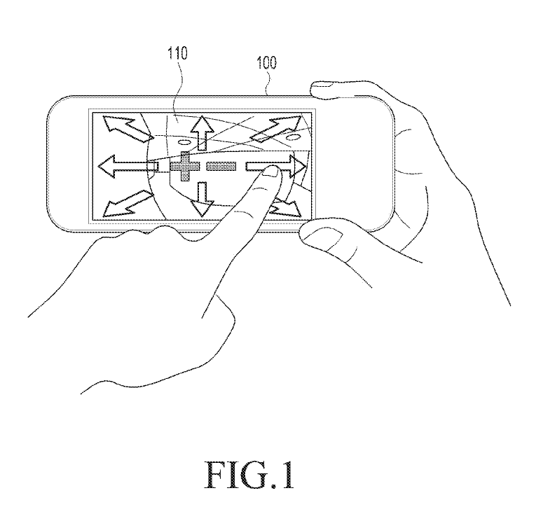

FIG. 1 illustrates an example of a user interface screen for pan/tilt/zoom (P/T/Z) control of a remote network camera using a mobile device such as a smart phone. Pan control is for left/right direction control, tilt control is for up/down direction control, and zoom control is for zoom in/out control.

In the example of FIG. 1, the user may enter and transmit a P/T/Z control command through a user interface (UI) 110 on a smart phone 100 in order to adjust the visual field (i.e., field of view (FoV)) of a remote network camera. If a P/T/Z control command is transmitted to the remote network camera, the FoV of the remote network camera is adjusted according to the P/T/Z control command, and the user may observe the adjusted image in the remote site where the remote network camera is installed, through the smart phone 100.

However, in the example of FIG. 1, a key input using user's both hands is required for camera control, with one hand holding the smart phone and the other touching a UI button on the touch screen for the control. Therefore, user convenience is low, creating a need to add an additional function for supporting hands-free remote control.

As another example of remote control of a device, there is technology for controlling consumer electronic devices through the user's line-of-sight by mounting an infrared (IR) emitter on a glasses-type wearable device. With this technology, it is possible to remotely control a device such as a home appliance by tracking the user's eyes through the glasses-type wearable device equipped with the IR emitter. However, this technology requires line-of-sight for transmission of IR control commands, causing spatial constraints.

As another example of remote control of a device, a user may install in a smart phone an application through which the user can check the operating state of a remote device through the UI of the installed application. However, in some cases, the UI of the application may not be accurately synchronized with the remote device due to a variety of variables such as failures in connection to the server or event scheduling errors. This may cause a command different from the user's intended command to be transmitted to the control target device. Therefore, methods for ensuring more accurate control of remote devices are required.

Accordingly, the present disclosure provides remote control methods using a wearable device so as to further improve the user's convenience in remote monitoring, solve the spatial constraints of remote device control, and ensure more accurate control of a remote device. The wearable device may be any of various types of wearable devices capable of detecting the movement of the user's head, such as, for example, a glasses-type wearable device or a head-mounted display (HMD)-type wearable device.

Further, the present disclosure provides methods, systems, and apparatuses for remote control of a device in a home network or building system using a smart watch, head tracking, voice recognition, and/or a touch interface. In one embodiment, a smart watch controls the movement of a remote network camera through P/T/Z control and voice recognition. The term ‘camera’ may be used herein to refer to the remote network camera.

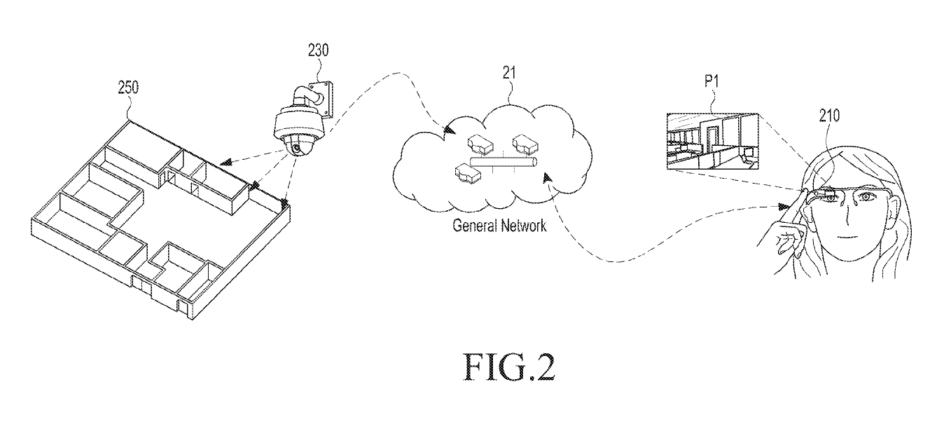

FIG. 2 is a diagram illustrating an example of a system for controlling the movement of at least one camera installed at a remote site using a wearable device according to an embodiment of the present disclosure.

In FIG. 2, glasses-type wearable device 210 receives an image captured by camera 230 at remote site 250 through network 21 in real time, and the user checks the received image P1 on the display screen of the wearable device 210. The glasses-type wearable device 210 worn on the user's head may transmit a P/T/Z control command corresponding to the user's head movement to the camera 230 through the network 21, and upon receiving the P/T/Z control command, the camera 230 may adjust its FoV according to the P/T/Z control command.

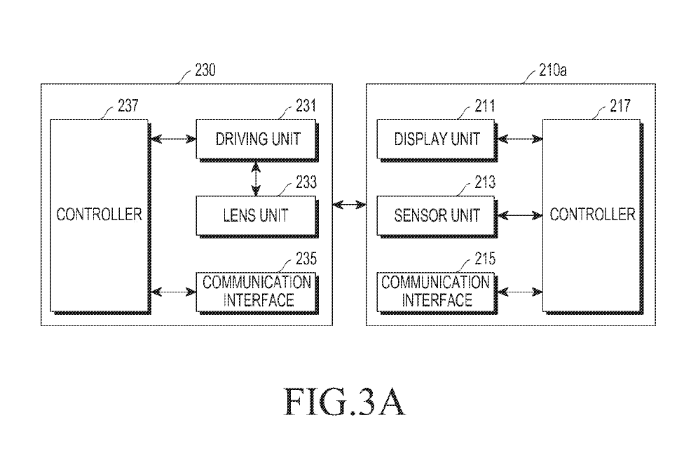

Further, the user may check the real-time image from the camera 230, and remotely control the operation of a device installed at the remote site 250 which can be seen within the FoV of the real-time image. Remote control of the device installed at the remote site 250 may be performed through a touch input or a key manipulation made on the wearable device 210 or through the recognition of a voice command, when the wearable device 210 includes a means for recognizing a voice command. The wearable device 210 may be implemented in a variety of ways, as shown by the examples in FIGS. 3A and 3B according to various embodiments of the present disclosure.

FIG. 3A is a block diagram illustrating an example of a wearable device and a remote-controlled camera according to an embodiment of the present disclosure. Although a plurality of cameras may be provided, it is assumed that only one camera is installed for convenience of description.

In FIG. 3A, wearable device 210a includes display unit 211, sensor unit 213, communication interface 215, and controller 217. Wearable device 210a can be any of various types of wearable devices capable of detecting the movement of the user's head, such as, for example, a glasses-type wearable device or an HMD-type wearable device. However, in the below-described embodiments of the present disclosure, a glasses-type wearable device is used for convenience of description.

In FIG. 3A, the display unit 211 is for displaying an image that is transmitted from the remote camera 230 in real time. The sensor unit 213 detects the head movement (e.g., up/down/left/right movement) of the user wearing the wearable device 210a, and outputs a value corresponding to the detected head movement. The communication interface 215 includes a wired/wireless communication module for transmitting control commands for controlling the movement of the camera 230 through the network 21, and receiving an image from the remote camera 230. The controller 217 is connected to the remote camera 230 through the communication interface 215, controls to receive an image from the remote camera 230 through the communication interface 215, and controls to display the received image on the display unit 211.

More specifically, the controller 217 may generate a P/T/Z control command so that a rotation angle of the remote camera 230 may be adjusted to correspond to the user's head movement detected by the sensor unit 213 which outputs a corresponding value to controller 217, and may transmit the generated P/T/Z control command to the camera 230 through the communication interface 215. The FoV of the camera 230 may be adjusted in any one or more of the up/down/left/right direction. For the sensor unit 213, a gyro sensor capable of detecting the user's head movement in the up/down/left/right direction may be used. Sensor unit 213 may be implemented as a plurality of sensors for precise motion detection.

In FIG. 3A, camera 230 includes driving unit 231, lens unit 233, communication interface 235 and controller 237. Camera 230 is a remote network camera for remote monitoring which may be used in, for example, the home or a commercial building. Driving unit 231 controls the movement of the lens unit 233 on which the camera lens is mounted, under control of the controller 237. The communication interface 235 includes a wired/wireless communication module for receiving a remote camera control command that is transmitted from the wearable device 210a through the network 21, and for adjusting the remote camera 230 depending on the transmitted control command. For example, upon receiving a P/T/Z control command, the controller 237 controls the movement of lens unit 233 through driving unit 231 in accordance with the received P/T/Z control command. Further, the controller 237 may control an operation of processing the image captured by the lens unit 233 and transmitting the processed image to the wearable device 210a.

FIG. 3B is a diagram illustrating an example of a remote control system for controlling a camera and an end device installed at a remote site using a wearable device according to an embodiment of the present disclosure.

The system in FIG. 3B includes wearable device 210b, camera 230, gateway 310 and end device 330. The wearable device 210b in FIG. 3B includes the functions of the wearable device 210a in FIG. 3A, and further includes functions for recognizing the user's voice command and transferring a control command corresponding to the voice command to the gateway 310. The voice command is for controlling the operation of the end device 330, and upon receiving the control command corresponding to the voice command, the gateway 310 controls an operation of the end device 330, such as On/Off control, in response to the control command.

The wearable device 210b in FIG. 3B includes a voice recognition unit 219 for recognition of the voice command. Any known voice recognition module may be used for voice recognition unit 219. Upon receiving the user's voice command through the voice recognition unit 219, the controller 217 transmits a control command corresponding to the voice command to the gateway 310. The transmitted control command may be configured in the form of a packet including the identification information and control information for the end device 330 which is the target of the control command. The control information may be a specific motion control command or a power on/off control command of the end device 330.

The packet carrying the control command may include user authentication information of the wearable device 210b. If the user is identified as a legitimate user based on the user authentication information, the gateway 310 controls the operation of the end device 330 in response to the received control command, and if the user is not identified as a legitimate user, the gateway 310 does not execute the received control command. In the wearable device 210b in FIG. 3B, except for the voice command-related functions, the other functions are the same as the functions of the wearable device 210a in FIG. 3A, and the functions of the camera 230 are also the same as those in the example of FIG. 3A, so detailed descriptions thereof are omitted.

In FIG. 3B, the gateway 310 receives control commands from the wearable device 210b to control the operation of the end device 330. In the system of FIG. 3B, the camera 230, the gateway 310 and the end device 330 are installed at the same remote site. The user using the wearable device 210b receives a remote image captured by the camera 230, and controls the operation of the end device 330 through voice commands. For example, in a building system, if an outsider's access is detected in the monitoring area of the camera 230, a remote control command such as turning on the lights in the area may be transmitted and performed.

As another example, in a home system, the user using the wearable device 210b checks the home situation remotely through camera 230, and then the user may give a voice command such as “Clean the Living Room” in order to operate a wireless cleaner among the home end devices 330. Then, the wearable device 210b recognizes “Clean” and “the Living Room”, respectively, and reads/determines that “Clean” is a command that should be transmitted to wireless cleaner home end device 330, and “the Living Room” is the cleaning location. Then, the wearable device 210b transmits, to the gateway 310, a packet (such as, e.g., a packet including the identification information of the wireless cleaner, the clean command, the cleaning position information and the like) including the control command corresponding to the recognition/reading results.

In FIG. 3B, the gateway 310 includes storage unit 311, user interface 313, communication interface 315 and controller 317.

The storage unit 311 is configured to store program code, data, and/or information required for an operation of the gateway 310 under control of its controller 317. For example, the storage unit 311 may store registration information of the one or more end devices 330, information about various control commands that can be transmitted from the wearable device 210b, and operating status information of the one or more end devices 330. Further, the storage unit 311 may store, depending on the embodiment, data that is received from the external device (such as, e.g., a system operator's terminal, a user's smart phone and the like). The user interface 313 may include at least one of various output modules such as a display, a speaker and an alert lamp, and various input modules such as a touch screen, a keypad and a microphone, and may be used by the user to directly control the gateway 310, register or remove an end device 330 as a control target in/from the gateway 310, or control an end device 330 through the gateway 310.

In FIG. 3B, the communication interface 315 in gateway 310 includes various wired/wireless communication modules for receiving, for example, a packet concerning a control command corresponding to the user's voice command from the wearable device 210b and transmitting a control signal for controlling an operation of the end device 330 in response to the control command. Upon receiving a control command from the wearable device 210b, the controller 317 transmits, through communication interface 315 to the end device 330, a control signal for controlling the operation of the end device 330 in response to the received control command. Following the example of cleaning the living room above, the controller 317 may transmit a control signal instructing the wireless cleaner end device 330 to “Clean” “the Living Room” through the communication interface 315. Further, upon the user's request, the controller 317 may control an operation for receiving information about the operating state or operating result (of a control command) of an end device 330, and for transmitting the received information about the operating state or operating result to the wearable device 210b.

In FIG. 3B, the end device 330 includes storage unit 331, user interface 333, communication interface 335, and controller 337.

The storage unit 331 stores a variety of information required for controlling the operation of the end device 330 in accordance with the control signal transmitted from the gateway 310. The control signal(s) may be classified for an On/Off operation control, a detailed operation control (e.g., operating time, operating position and the like), etc. The control signal(s) predetermined for various operation controls between the end device 330 and the gateway 310 may be registered and used. Further, the storage unit 331 may store the operating status records of the end device 330. The location and/or relative position of the end device 330 may be determined using a radio frequency (RF) tag, a sensor and the like.

The user interface 333 may include at least one of various output modules such as a display, a speaker and an alert lamp, and various input modules such as a touch screen, a keypad and a microphone, and may be used for controlling the operation of the end device 330. Upon receiving a control signal from the gateway 310, the controller 337 controls the operation of the end device 330 according to the received control signal. Further, the controller 337 may transmit the result or status information, which is determined by the operation according to the received control signal, to the gateway 310 through the communication interface 335. The communication interface 335 may include various wired/wireless communication modules for receiving a control signal from the gateway 310 and transmitting an operation result or operation status information to the gateway 310.

Hereinafter, “wearable device 210” may refer to any wearable device capable of detecting user movement, such as, for example, a glasses-type wearable device, a head-mounted display (HMD)-type wearable device, the wearable device 210a in FIG. 3A, and the wearable device 210b in FIG. 3B.

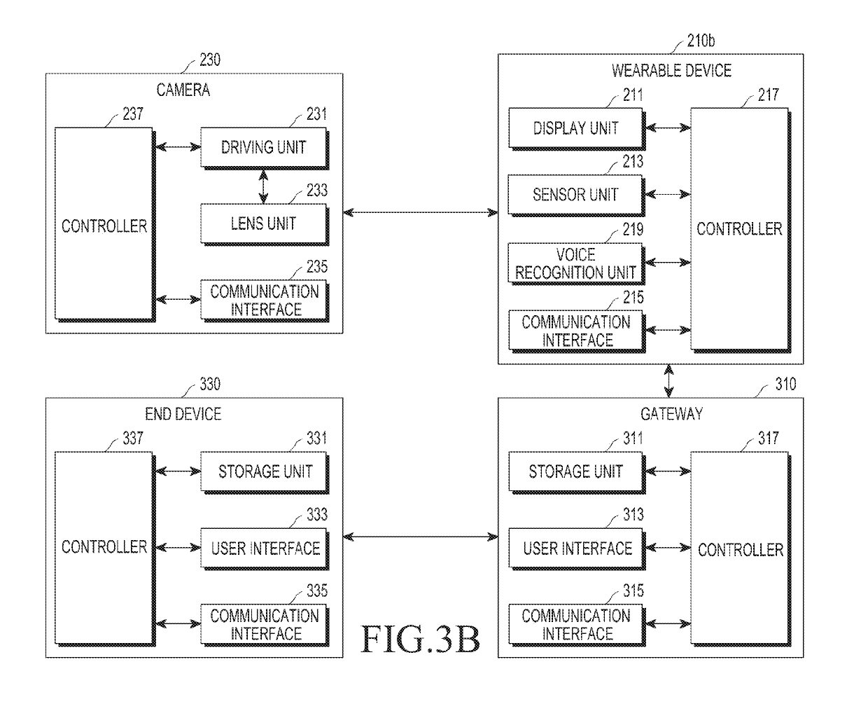

FIG. 4 is a diagram illustrating an example of a communication interface that may be used in accordance with an embodiment of the present disclosure in any of wearable device 210, remote camera 230, gateway 310, and end device 330. In FIG. 4, communication interface 400 includes various wired/wireless communication protocol-based modules, such as WiFi or 802.xx-based wireless LAN module 401, ZIGBEE™ module 403, a BLUETOOTH™ module 405, a near-field communication (NFC) module 407, a Z-WAVE module 409, and a wired communication module 411. Z-WAVE is one of the radio frequency (RF) technologies that are used for home networks or the like. Depending on the embodiment, the communication interfaces of the wearable device 210, the remote camera 230, the gateway 310 and the end device 330 may use at least one of the modules illustrated in FIG. 4, and/or may use a variety of well-known wired/wireless communication modules in addition to those illustrated in FIG. 4.

In various embodiments of the present disclosure, it is assumed that the end device 330 communicates with the gateway 310 using the ZIGBEE™-based home automation profile (HAP) or smart energy profile (SEP), and the camera 230 communicates with the wearable device 210 using a WiFi network.

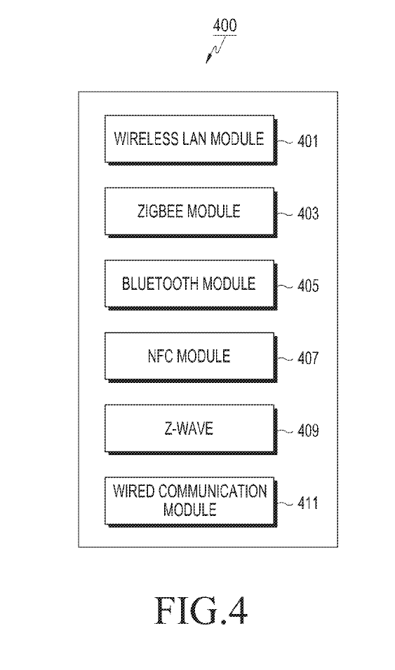

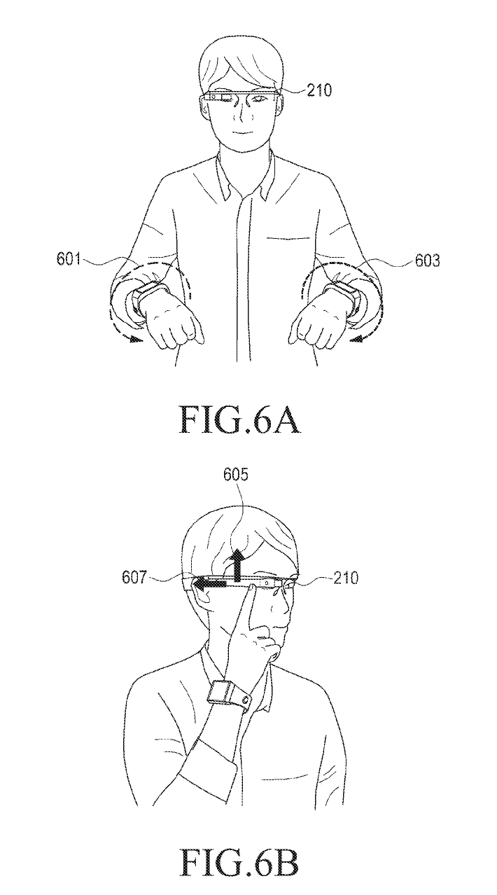

FIG. 5 is a diagram illustrating head movements for a camera control method using a wearable device according to an embodiment of the present disclosure. FIG. 7 illustrates the resulting pan and tilt operations of a remote camera.

In FIG. 5, the user wearing the wearable device 210 on his/her head may access of a remote camera through, for example, voice command or touch input. Once remote access is made, the real-time image captured by the remote camera is transmitted to the wearable device 210 through a network such as the network 21 using, for example, the real time streaming protocol (RTSP). The user checks the received image on the display screen of the wearable device 210.

Thereafter, the user may move her/his head to control the movements of the remote camera. If the user's head horizontally rotates (i.e., yaws) in the left/right direction as shown by reference numerals 507 (Yaw-Left) or 509 (Yaw-Right) in FIG. 5 in order to control the FoV of the remote camera, the remote camera pans with the same left/right movement 703 as shown in FIG. 7. If the user's head vertically rotates (i.e., tilts or pitches) in the up/down direction as shown by reference numerals 503 (Pitch-Up) and 505 (Pitch-Down) in FIG. 5, the remote camera tilts with the same up/down movement 701 as shown in FIG. 7. The change in angle of the camera 230 may be controlled using an application programming interface (API) between the camera 230 and the wearable device 210.

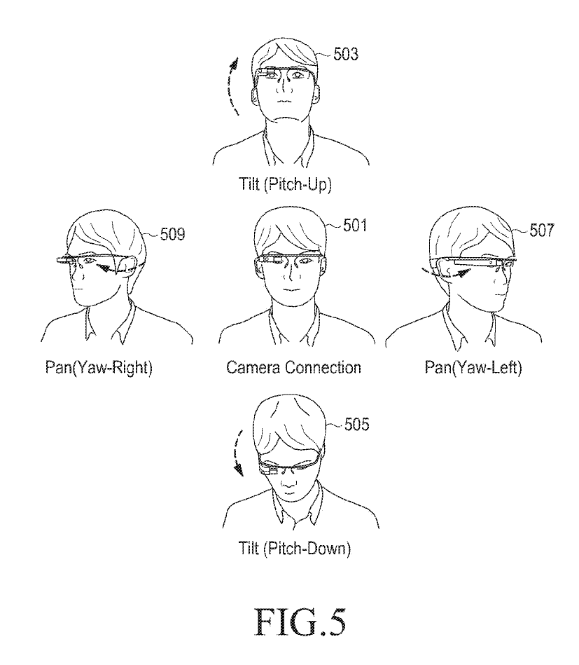

FIGS. 6A and 6B are diagrams showing hand gestures and touch input, respectively, for remote camera control according to embodiments of the present disclosure.

FIG. 6A illustrates a camera control method by hand movements using a pair of smart watches having a communication connection with a glasses-type wearable device 210. Each of the smart watches detects the rotations of each of the user's wrists and transmits the detection results to the wearable device 210. If the detected rotation of the left wrist 603 or right wrist 601 is greater than or equal to an associated threshold, the wearable device 210 performs panning or tilting, respectively, of the remote camera.

FIG. 6B illustrates a camera control method using the user's touch input to the glasses-type wearable device 210. If the user makes a touch input by rubbing a touch interface included in the wearable device 210 in the up/down or left/right direction using his/her finger, the wearable device 210 performs panning or tilting, respectively, of the remote camera.

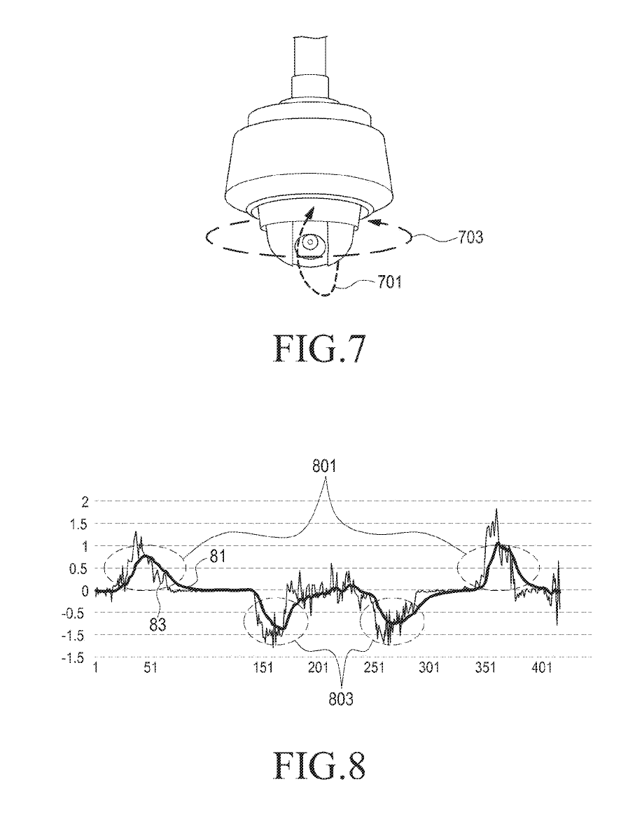

FIG. 8 is a graph of sensor data of remote camera control using head tracking in a wearable device according to an embodiment of the present disclosure. This graph shows examples of a head tracking waveforms detected by, for example, a gyro sensor in the wearable device 210. The Y-axis indicates the output value of the gyro sensor. Referring to FIG. 8, reference numeral 801 indicates two head tracking waveforms detected by the gyro sensor when the user's head was moving toward the right side, and reference numeral 803 indicates two head tracking waveforms detected by the gyro sensor when the user's head was moving toward the left side.

The actual head tracking waveform detected by the gyro sensor may have fluctuations like the waveform represented by the thin solid line 83 in FIG. 8. The fluctuations may make stable control of the remote camera difficult. In an embodiment of the present disclosure, a Kalman filter may be applied to compensate for the fluctuation in the sensor data of the gyro sensor. The waveform 81 shown by the thick solid line in FIG. 8 represents a waveform, the fluctuations of which are compensated for by the application of the Kalman filter to the sensor data. Other known filters may be used, as long as they can compensate for the fluctuations.

In the glasses-type wearable device 210, when the user's head has moved from side to side, the Y-axis movement may show the waveform of the graph in FIG. 8.

For example, if the user rotates his/her head to the right and the sensor data has a value between 0.00˜+1.00, the movement of the remote camera, which is synchronized with the head rotation, is to pan with a rotation value between 0° ˜+90°. If the user rotates his/her head to the left and the sensor data has a value between −1.00˜0.00, the movement of the remote camera, which is synchronized with the head rotation, is to pan with a rotation value between −90° ˜0°.

In this case, the control value of the API for control of the remote camera is as shown in Table 1 below.

TABLE 1

| Head Movement | Sensor Value (Y) | Camera Angle | API |
|---|---|---|---|
| Right way | 0.00~+1.00 | 0°~+90° | 1, 0 |
| Left way | −1.00~0.00 | −90°~0° | −1, 0 |

On the other hand, if the user turns his/her head upward and the sensor data has a value between 0.00˜+1.00, the movement of the remote camera, which is synchronized with the head rotation, is to tilt with a rotation value between 0° ˜+30°. If the user turns his/her head downward and the sensor data has a value between −1.00˜0.00, the movement of the remote camera 230, which is synchronized with the head rotation, is to tilt with a rotation value between −30° ˜0°.

In this case, the control value of the API for control of the remote camera is as shown in Table 2 below.

TABLE 2

| Head Movement | Sensor Value (Y) | Camera Angle | API |
|---|---|---|---|
| Up way | 0.00~+1.00 | 0°~+30° | 0, 1 |
| Down way | −1.00~0.00 | −30°~0° | 0, −1 |

Further, the present disclosure proposes algorithms of Equation (1) and Equation (2) below so that the pan control and tilt control, to which Equation (1) and Equation (2) are applied, are performed in the same manner. As for the sensor data of the gyro sensor, when the user's head rotates (or, equivalently, when the gyro sensor moves), a plurality of noise data may be generated, so the camera may move inaccurately. The algorithms of Equation (1) and Equation (2) may be applied to compensate for the noise data caused by the movement of the gyro sensor mounted on the wearable device.

According to an embodiment of the present disclosure, if the filters defined as the following Equation (1) and Equation (2) are applied, the camera that is controlled during the rotation of the user's head may have a more smooth motion.

$$\begin{matrix}X = X + ( {SensorValue}_{t} - X ) \times K & ( 1 ) \\ K = \frac{P + Q}{P + Q + R} \\ P = \frac{R \times ( P + Q )}{R + P + Q} & ( 2 )\end{matrix}$$

Table 3 below defines the variables in Equations (1) and (2).

TABLE 3

| Variables | Definition |
|---|---|
| X | (filter-applied) corrected SensorValueₜ value |
| SensorValueₜ | Raw data value of sensor data measured at time t |
| K | System measurement vector at time t |
| P | Processing noise value at time t |
| Q | Constant (predefined value) defined by algorithm |
| R | Estimation noise value at time t |

Equation (1) is for performing filtering so that the real-time sensor data of the gyro sensor may have an adjusted value (as shown by reference numeral 81 in FIG. 8), and Equation (2) is for measuring the variables in Equation (1). In Table 3, the P value may be an estimated value of the noise that is linearly calculated at time t, and the R value may be experimentally estimated as a value of the noise estimated at time t, and may be used to determine a compensated value for the noise. That is, the P value is the estimated value of the noise that is linearly compensated by using the R value.

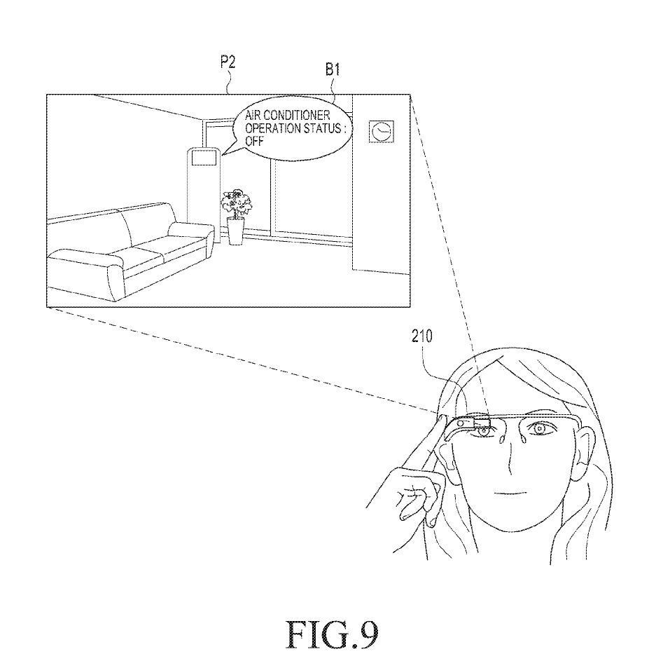

FIG. 9 illustrates an example of controlling an end device installed at a remote site using a wearable device supporting augmented reality (AR) according to an embodiment of the present disclosure.

The configurations and functions of the wearable device, the camera, the gateway and the end device as described in the embodiment of FIG. 3B may be equally implemented in the system of FIG. 9. Further, in the embodiment of FIG. 9, a function capable of displaying the operating status of the end device using AR, and controlling the operation of the wearable device 210 may be additionally implemented in the wearable device 210 and the gateway.

In FIG. 9, wearable device 210 receives in real time the image P2 captured by a camera at a remote site through a communication network. The received image P2 is checked by the user on the display screen of the wearable device 210. The wearable device 210 transmits P/T/Z control commands corresponding to the user's movement to the remote camera through the communication network, and upon receiving the P/T/Z control commands, the remote camera controls its movement in accordance with the P/T/Z control commands. If the AR is executed in the wearable device 210, the current operating status of an end device, such as the air conditioner in image P2, may be displayed on the display screen of the wearable device 210 as shown by reference numeral B1 in FIG. 9.

To this end, the gateway, such as gateway 310, controls an operation of receiving information about the operating status of the end device from the end device and transmitting the received information to the wearable device 210. Further, the gateway may operate as an AR server so as to provide the information about the operating status of the end device to the wearable device 210 through AR, and a program supporting AR as a client may be installed in the wearable device 210.

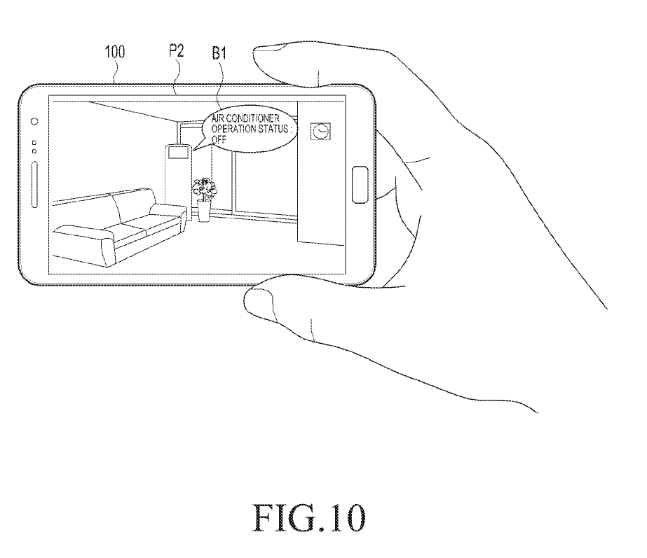

FIG. 10 illustrates an example of controlling an operation of an end device installed at a remote site using a mobile device supporting AR according to an embodiment of the present disclosure. The embodiment of FIG. 10 performs the same operation as that in the embodiment of FIG. 9. In this example, the function of the wearable device 210 in the embodiment of FIG. 9 is implemented in a mobile device, i.e., smart phone 100. The operations in the embodiment of FIG. 10 are provided through the embodiments described above, such as in in FIGS. 1 and 9, so a detailed description thereof is omitted.

According to the above embodiments, it is possible to capture in real time images within a remote location, such as a home or building, through a networked camera. According to the above embodiments, methods of remote control are provided which thereby further improve user convenience for FoV control of a remote camera. Further, according to the above embodiments, it is possible to receive image information from the remote camera using a wearable device, and remotely control the movement of the camera using the wearable device, a separate smart watch, touch input, such as finger swipes, sensor input, such as head movement tracking, or the like. In some embodiments, it is possible to resolve the inconvenience of a user using both his/her hands for camera control, as in, for example, remote monitoring system using a smart phone.

Further, according to the above embodiments, the user may check the situation of a remote site through an on-site camera using a wearable device, and control the operation of a remote end device at that remote site through a voice command.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should only be defined by the appended claims and their equivalents.

What is claimed is:

1. A method of remote control using a wearable device, comprising:
establishing a communication connection with a remote camera over a network; and
controlling a field of view of the remote camera according to a detected movement of a user wearing the wearable device.

2. The method of claim 1, wherein the wearable device is a glasses-type wearable device.

3. The method of claim 1, wherein the detected user's movement is head movement.

4. The method of claim 1, wherein the detected user's movement includes a wrist movement of the user wearing a smart watch which is separate and distinct from the wearable device.

5. The method of claim 1, wherein the detected user's movement includes a touch input.

6. The method of claim 1, further comprising:
controlling an operation of a remote device within the FoV of the remote camera by recognizing a voice command of the user.

7. A wearable device, comprising:
a communication interface;
a sensor unit; and
a controller configured to establish a communication connection with a remote camera over a network, and control a field of view (FoV) of the remote camera according to a movement of the user wearing the wearable device detected by the sensor unit.

8. The wearable device of claim 7, wherein the wearable device is a glasses-type wearable device.

9. The wearable device of claim 7, wherein the detected user's movement is head movement.

10. The wearable device of claim 7, wherein the detected user's movement includes a wrist movement of the user wearing a smart watch which is separate and distinct from the wearable device.

11. The wearable device of claim 7, wherein the detected user's movement includes a touch input.

12. The wearable device of claim 7, wherein the controller is configured to control an operation of a remote device within the FoV of the remote camera by recognizing a voice command of the user.

13. A method for remote control using a mobile device, comprising:
establishing, by the mobile device, a communication connection with a remote camera over a network; and
controlling a field of view of the remote camera according to a movement of the mobile device detected by a sensor, wherein controlling comprises:
compensating for noise data of the sensor detecting the movement.

14. The method of claim 13, wherein the noise data of the sensor is linearly compensated by using an estimated value of noise calculated by applying a compensation value of the noise at each time.

15. The method of claim 13, further comprising:
receiving an image captured by the remote camera; and
displaying an operating status of an end device shown in the captured image, using augmented reality (AR).

16. The method of claim 15, further comprising:
transmitting a control command for controlling an operation of the end device to a gateway capable of controlling an operation of the end device.

17. A mobile device, comprising:
a display unit;
a communication interface;
a sensor unit; and
a controller configured to establish a communication connection with a remote camera over a network via the communication interface, and control a field of view of the remote camera according to a movement detected by the sensor unit,
wherein controlling the FoV comprises:
compensating for noise data of the sensor unit detecting the movement.

18. The mobile device of claim 17, wherein the controller is further configured to linearly compensate for the noise data of the sensor using an estimated value of noise calculated by applying a compensation value of the noise at each time.

19. The mobile device of claim 17, wherein the controller is further configured to receive an image captured by the remote camera, and display an operating status of an end device shown in the captured image, using augmented reality (AR).

20. The mobile device of claim 19, wherein the controller is further configured to transmit a control command for controlling an operation of the end device to a gateway capable of controlling an operation of the end device.
